(19) United States
(12) Patent Application Publication
(10) Pub. No.: US 2017/0161120 A1
(43) Pub. Date: Jun. 8, 2017

(54) INFORMATION PROCESSING SYSTEM AND NETWORK RESOURCE MANAGEMENT METHOD

(71) Applicant: NEC Corporation, Tokyo (JP)

(72) Inventors: Takayuki SASAKI, Tokyo (JP); Takeo HAYASHI, Tokyo (JP); Kentaro SONODA, Tokyo (JP); Yoichi HATANO, Tokyo (JP); Toshiki WATANABE, Tokyo (JP)

(73) Assignee: NEC Corporation, Tokyo (JP)

(21) Appl. No.: 15/327,563

(22) PCT Filed: Jul. 17, 2015
(86) PCT No.: PCT/JP2015/003629

§ 371 Date: Jan. 19, 2017

(30) Foreign Application Priority Data
Jul. 22, 2014 (JP) 2014-148667

(51) Int. Cl. G06F 9/54

(52) U.S. Cl. CPC G06F 9/541

(57) ABSTRACT

This invention provides an information processing system for controlling, in the management of network resources, with a desired accuracy and at a lower cost, whether to perform operations for the network resources. The information processing system comprises a means that performs a determination as to whether to execute an Application Programming (API) called up by an operating subject and used for controlling the network resources, said determination being performed on the basis of a correspondence among the operating subject, a tenant that is a set consisting of the network resources for which the operating subject has been permitted to perform operations, and the API for which the execution by the operating subject has been permitted. This means then controls the execution of the API on the basis of a result of the determination.

### TECHNICAL FIELD

The present invention relates to a technology for controlling the propriety of operating network resources.

### BACKGROUND ART

Recent years, a technology referred to as Software Defined Network (SDN) has been developed. The SDN is a general term for technologies in which, differing from a fixed network that is constructed using hardware, software of a controller that manages a network and configuration thereof enable configuration change and function expansion of the network. The SDN is also a general term for networks that are constructed using such technologies.

A technology referred to as OpenFlow has been proposed as an SDN. NPLs 1 and 2 disclose characteristics of OpenFlow and the specifications of the OpenFlow switch.

One of the characteristics of OpenFlow is that a control plane (functions such as routing control of a network) and a data plane (functions of packet transfer control) are separated. OpenFlow is made up of an OpenFlow controller and a plurality of OpenFlow switches. The OpenFlow switches perform packet transfer in accordance with instructions from the OpenFlow controller.

Specifically, each of the OpenFlow switches has a set of rules for packet transfer, referred to as a Flow Table, on the inside thereof. In the Flow Table, a plurality of packet transfer rules, referred to as Flow entries, are recorded. A Flow entry is made up of a match field and an action field. The match field is a field in which a condition, such as a MAC (Media Access Control) address and an IP (Internet Protocol) address, is specified. The action field is a field in which an action, such as transferring and discarding, is specified.

When receiving a packet, each of the OpenFlow switches searches the Flow Table for a Flow entry that matches with the packet. Subsequently, when detecting a Flow entry matching with the packet, the OpenFlow switch performs an action specified by the Flow entry.

If no Flow entry matching with the packet is detected, the OpenFlow switch transmits an inquiry (Packet_in message) to the OpenFlow controller.

The OpenFlow controller, depending on the received Packet_in message, transmits a Packet_out message or a Flow_mod message to the OpenFlow switch. The Packet_out message is a command for instructing transmission (transfer) of a packet. The Flow_mod message is a command instructing addition of a Flow entry to the Flow Table of the OpenFlow switch.

Next, the OpenFlow switch performs transfer of the packet or addition of a Flow entry in accordance with the message received from the OpenFlow controller.

The above-described OpenFlow controller provides APIs (Application Programming) to an application, an administrator, or the like (hereinafter, also referred to as an operating subject). Such an operating subject transmits commands to the OpenFlow controller by way of the APIs to operate network resources.

However, in the technologies disclosed in the above-described NPLs 1 and 2, there has been a problem that the technologies have security risks because no determination of execution propriety of OpenFlow APIs is performed.

Technologies for solving such a problem are described in NPLs 3 and 4.

For example, conventional operating systems for computers manage access authorities to files and the like and restrict operations permitted to respective users. By taking such a measure, even in the case of being accessed by a malicious user, the operating systems are capable of limiting the extent of influence. Applying the concept to APIs of the OpenFlow controller enables security risks in OpenFlow to be reduced.

For example, NPL 3 discloses a technology of performing control by allocating available authorities to OpenFlow applications (operating subjects).

NPL 4 discloses a technology of authenticating OpenFlow applications using signatures and a technology of solving a conflict between rules using priorities of applications.

PTL 1 discloses a domain-based Access Control List (ACL) and Role Based Access Control (RBAC), which is a role-based access control policy.

The ACL and RBAC are policies that are generally used for access control.

The ACL includes rules each specifying a permission or a prohibition for each of an operating subject (subject), an operation object (object), and an operation (action).

The RBAC solves the above-described problem concerning the ACL by using a concept referred to as a Role. The Role is a set of pairs of an object and an action, that is, a set of pieces of information each indicating what type of operation can be performed on which resource (object). Such a Role being allocated to a subject enables an RBAC policy to include rules representing authorities of the subject.

In the case of the ACL, when an authority is to be changed, a plurality of ACLs need to be altered. However, in the case of the RBAC, when an authority is to be changed, only the definition of a Role may be changed, which causes the management load of the RBAC to be smaller than that of the ACL. When, for example, access to a specific server is permitted to the employees in a specific business unit, while, in the case of using the ACL, the ACLs of all the employees in the specific business unit need to be altered, in the case of using the RBAC, only adding an access authority of the specific server to the Role of the specific business unit is applicable.

### CITATION LIST

### Patent Literature

PTL 1: Japanese Patent Application Laid-open Publication (Translation of PCT Application) No. 2009-539183

### Non Patent Literature

NPL 1: Nick McKeown et al. “OpenFlow: Enabling Innovation in Campus Networks” SIGCOMM Computer Communication Review 38, ACM, 2008, pages 69-74.
NPL 2: “OpenFlow Switch Specification” Version 1.1.0 Implemented (Wire Protocol 0X02), [online], [retrieved on Jun. 21, 2012], internet <URL:http://www.openflow.org/documents/openflow-spec-v1.1.0.pdf>
NPL 3: Xitao Wen et al. “Towards a Secure Controller Platform for OpenFlow Applications” HotSDN'13 Proceedings of the second ACM SIGCOMM workshop on Hot topics in software defined networking, ACM, Aug. 16, 2013, pages 171-172.
NPL 4: Phillip Porras et al. “A Security Enforcement Kernel for OpenFlow Networks” HotSDN '12 Proceedings of the first workshop on Hot topics in software defined networks, ACM, Aug. 13, 2012, Pages 121-126.

### SUMMARY OF INVENTION

### Technical Problem

In the management of network resources, controlling the propriety of operation of the network resources with a desired accuracy and at a lower cost is demanded.

The technologies disclosed in NPLs 3 and 4 may not individually control “which operation” to “which network resource” performed by “which application or administrator” is permitted or prohibited. That is, the technologies disclosed in NPLs 3 and 4 are incapable of controlling the propriety of execution of an individual API (control of a network resource) with respect to each combination of an operating subject (application or administrator), a network resource, and an operation. In other words, the technologies disclosed in NPLs 3 and 4 have a problem that the technologies are not always able to control network resources with a desired accuracy.

That is because the technologies disclosed in NPLs 3 and 4 do not take into consideration a viewpoint of “which network resource”.

The ACL and RBAC disclosed in PTL 1 have a problem that, in an environment, such as an SDN, in which the configuration changes dynamically, the maintenance of a Role takes a cost.

That is because, as described afore, an ACL individually specifies permission or prohibition with respect to each combination of a subject, an object, and an action. That is also because, in an RBAC, a Role is a set of an object and an action, that is, a set of pieces of information in which an action is described for each resource. That is, because, when function enhancement of the controller causes addition of a new action and elimination and consolidation of types of actions, such a Role need to check the set of a subject and an action in the all Role and update related policies.

An object of the present invention is to provide an information processing system, a network resource management method, and a program therefor or a computer-readable non-transitory recording medium recording the program that achieve an object to control the propriety of operation to the network resource with a desired accuracy and at a lower cost.

### Solution to Problem

An information processing system according to the one aspect of the present invention includes:

execution propriety determination means for, based on a first policy and a second policy, determining propriety of execution of an application programming interface that is called by an operating subject and is used for controlling a network resource, and, based on the determined propriety of the execution, instructing, to means for executing the application programming interface, execution of the application programming interface,

the first policy indicating a correspondence between the operating subject and a tenant that is a set of the network resources that the operating subject is permitted to operate, and the second policy indicating a correspondence between the operating subject and an application programming interface the execution of which by the operating subject is permitted.

A network resource management method according to the one aspect of the present invention, the method includes:

determining propriety of execution of an application programming interface that is called by an operating subject and used for controlling a network resource based on a first policy that indicates a correspondence between the operating subject and a tenant that is a set of the network resources that the operating subject is permitted to operate and a second policy that indicates a correspondence between the operating subject and an application programming interface the execution of which by the operating subject is permitted; and

based on the determined propriety of the execution, instructing, to means for executing the application programming interface, execution of the application programming interface.

A data structure according to the one aspect of the present invention,

the data structure being used, in an information processing system, for determining propriety of execution of an application programming interface that is called by an operating subject and is for controlling a network resource,

the data structure associating tenants each of which is an arbitrary set of the network resources in respective ones of a controller, a switch, specifications, and capabilities that relate to the network with the operating subjects that are permitted to operate the network resources included in the tenants in a many-to-many relationship, and

the data structure associating the application programming interfaces with the operating subjects that are permitted to execute the application programming interfaces in a many-to-many relationship.

A computer-readable non-transitory recording medium recording a program according to the one aspect of the present invention, the program making a computer execute processes of:

determining propriety of execution of an application programming interface that is called by an operating subject and used for controlling a network resource based on a first policy that indicates a correspondence between the operating subject and a tenant that is a set of the network resources that the operating subject is permitted to operate and a second policy that indicates a correspondence between the operating subject and an application programming interface the execution of which by the operating subject is permitted; and

based on the determined propriety of the execution, instructing, to means for executing the application programming interface, execution of the application programming interface.

### Advantageous Effects of Invention

The present invention enables execution propriety control of APIs that provide controlling functions of network resources to be achieved for each combination of an operating subject, a network resource, and an operation at a lower cost.

### BRIEF DESCRIPTION OF DRAWINGS

FIG. 1 is a block diagram illustrating a configuration of a network resource management system according to a first example embodiment of the present invention;

FIG. 2 is a block diagram illustrating a configuration of an information processing system including the network resource management system in the first example embodiment of the present invention;

FIG. 3 is a diagram illustrating an example of a logical structure of resource operation authority policies in the first example embodiment;

FIG. 4 is a diagram illustrating an example of a resource tenant table that is a portion of the resource operation authority policies in the first example embodiment;

FIG. 5 is a diagram illustrating an example of an operating subject tenant table that is a portion of the resource operation authority policies in the first example embodiment;

FIG. 6 is a diagram illustrating an example of a logical structure of API call authority policies in the first example embodiment;

FIG. 7 is a diagram illustrating an example of an operating subject API table indicating the API call authority policies in the first example embodiment;

FIG. 8 is a diagram illustrating an example of an internal configuration of an API execution propriety determination unit in the first example embodiment;

FIG. 9 is a block diagram illustrating a hardware configuration of a computer that achieves a network resource management device according to the first example embodiment;

FIG. 10 is a sequence diagram illustrating an operation of the information processing system in the first example embodiment;

FIG. 11 is a flowchart illustrating an operation of the API execution propriety determination unit in the first example embodiment;

FIG. 12 is a block diagram illustrating a configuration of a network resource management system according to a variation of the first example embodiment;

FIG. 13 is a diagram illustrating an example of a logical structure of resource operation authority policies in a second example embodiment of the present invention;

FIG. 14 is a diagram illustrating an example of a resource tenant table indicating a portion of the resource operation authority policies in the second example embodiment; and

FIG. 15 is a block diagram illustrating a configuration of an information processing system according to a third example embodiment of the present invention.

### DESCRIPTION OF EMBODIMENTS

Example embodiments for embodying the present invention will be described in detail with reference to the accompanying drawings. In the respective drawings and the respective example embodiments described in the description, the same components are provided with the same reference signs and a description thereof will be omitted appropriately.

### <<<First Example Embodiment>>>

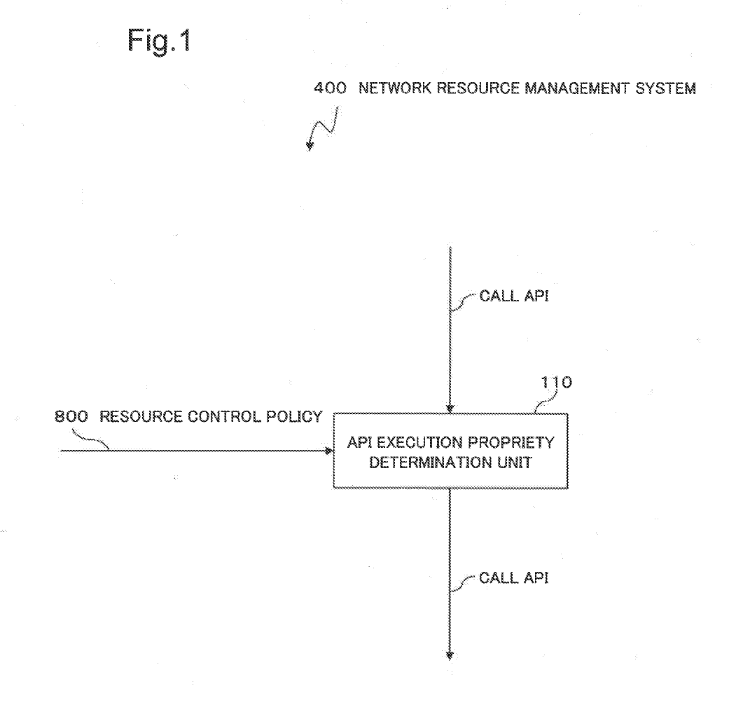

FIG. 1 is a block diagram illustrating a configuration of a network resource management system (also referred to as an information processing system) 400 according to a first example embodiment of the present invention.

As illustrated in FIG. 1, the network resource management system 400 according to the present example embodiment includes an API execution propriety determination unit 110.

The respective components illustrated in FIG. 1 may be not only electrical circuits of hardware units but also components into which a computer device is divided in accordance with functional units. The following description will be made assuming that the components illustrated in FIG. 1 are components into which a computer device is divided in accordance with functional units.

===API Execution Propriety Determination Unit 110===

The API execution propriety determination unit 110 determines the propriety of execution of an API that has been called by an operating subject (not illustrated) and is used for controlling a network resource on the basis of resource control policies 800. Next, based on the determined propriety of execution, the API execution propriety determination unit 110 calls the API, which is provided by means (not illustrated) for executing the API. The structure of the resource control policies 800 is, in general, also referred to as a data structure.

The resource control policies 800 include first policies and second policies. Each first policy indicates a correspondence with a tenant. The tenant is a set of the operating subject and the resources that the operating subject is permitted to operate. The tenant is also referred to as a slice, a container, or a domain. Each second policy indicates a correspondence between the operating subject and APIs that the operating subject is permitted to execute.

The operating subject is, for example, a subject such as an administrator and an application, that operates the network resources.

The means for executing an API is, for example, means for controlling the network resource based on the called API.

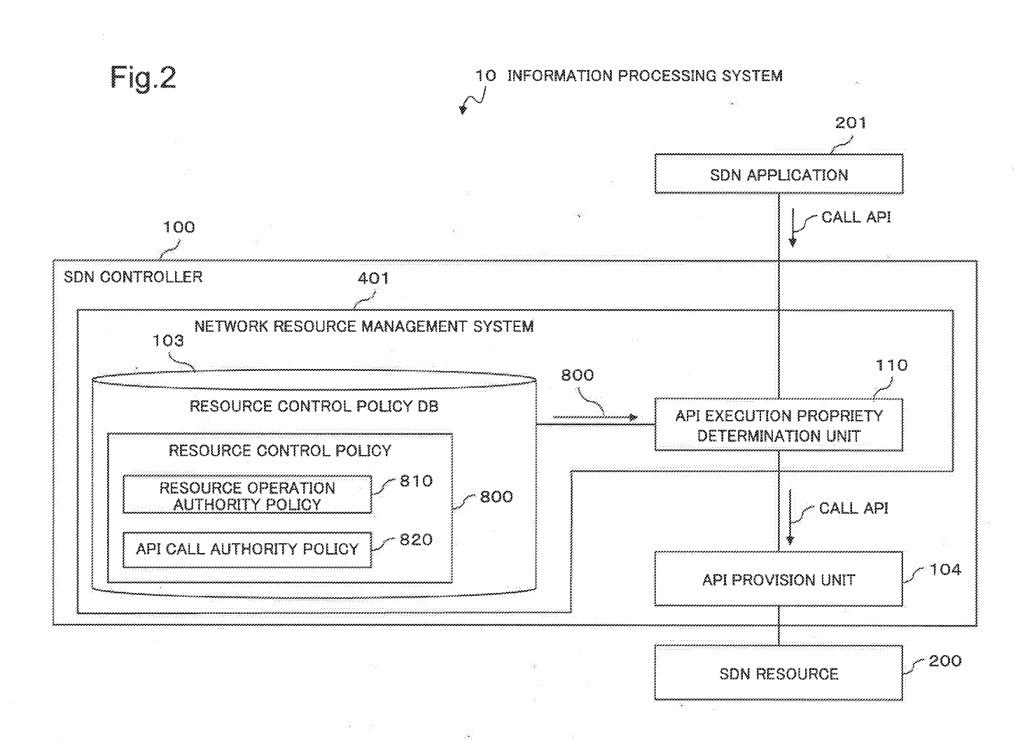

FIG. 2 is a block diagram illustrating a configuration of an information processing system 10 including a network resource management system 401 according to the present example embodiment.

As illustrated in FIG. 2, the information processing system 10 includes an SDN controller 100, an SDN resource (also referred to as a network resource) 200, and an SDN application (also referred to as an operating subject) 201.

===SDN Application 201===

The SDN application 201 is an application that, by calling an API provided by the SDN controller 100, provides various network services, such as a firewall and a load balancer. Although, in FIG. 2, an SDN application 201 is illustrated representatively, the types and the number of SDN applications 201 may be defined arbitrarily.

===SDN Resource 200===

The SDN resource 200 is a network resource that is executed in response to an instruction received from the SDN controller 100 and performs packet transfer, packet transformation, and the like. For example, the network resource is the SDN controller 100 itself, and a CPU (Central Processing Unit), a memory or the like of the SDN controller 100, or the like. The network resource is a switch, a router, and CPUs, ports or the like of the switch and router. The network resource may be network specifications, such as a bandwidth and a VLAN (Virtual Local Area Network) ID (Identifier). The network resource may be a capability of a tenant, such as an access control list (rules used by a firewall) for communication inside the tenant and whether or not a broadcast can be executed in the tenant. The network resource may be, without being limited to the above-described examples, an arbitrary resource. Although, in FIG. 2, an SDN resource 200 is illustrated representatively, the types and the number of SDN resources 200 may be defined arbitrarily.

===SDN Controller 100===

The SDN controller 100 provides, to the SDN application 201, APIs for operating the SDN resource 200.

The SDN controller 100 includes the API execution propriety determination unit 110, a resource control policy DB (Database) (also referred to as a policy storage means) 103, and an API provision unit 104. The API execution propriety determination unit 110 and the resource control policy DB 103 are also referred to as the network resource management system 401 collectively.

===Resource Control Policy DB 103===

The resource control policy DB 103 stores resource control policies 800 for controlling the propriety of execution of APIs for operating SDN resources 200. The resource control policies 800 include resource operation authority policies 810, which are first policies, and API call authority policies 820, which are second policies. Each resource operation authority policy 810 sets forth an SDN resource(s) 200 that can be operated by a certain SDN application 201. Each API call authority policy 820 sets forth an API(s) that can be called (executed) by a certain SDN application 201.

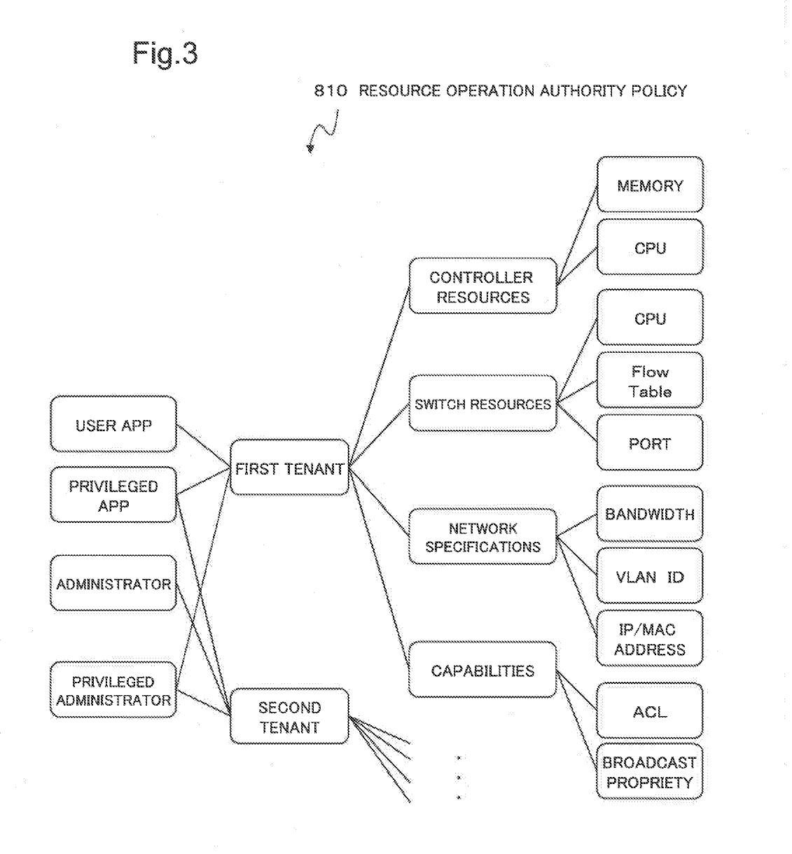

FIG. 3 is a diagram illustrating an example of a logical structure of the resource operation authority policies 810.

As illustrated in FIG. 3, the resource operation authority policies 810 indicate how tenants, each of which is a set of SDN resources 200, and operating subjects (for example, an application, such as an SDN application 201, and an administrator) are linked with each other.

FIG. 3 illustrates that a first tenant is linked with four resource groups, including controller resources, switch resources, network specifications, and capabilities.

Furthermore, FIG. 3 illustrates that the controller resources are amounts of allocation of a memory and a CPU to the SDN controller 100.

FIG. 3 also illustrates that the switch resources are an amount of CPU allocation to a switch, physical ports of the switch, and an amount of allocation of FlowTable of the OpenFlow switch and an allocated area.

FIG. 3 also illustrates that the network specifications are a bandwidth, a VLAN ID, and IP/MAC addresses.

FIG. 3 also illustrates that the capabilities are an ACL (Access Control List, indicating rules for a firewall) for communication inside the tenant and the propriety of performing a broadcast in the tenant.

The resource operation authority policies 810 indicate links between operating subjects and tenants in an N:N (many-to-many) relationship. In other words, an operating subject may be linked with a plurality of tenants and a tenant may be linked with a plurality of operating subjects.

For example, FIG. 3 illustrates that a “user APP (Application)” is linked with the “first tenant”. This link indicates that the “user APP” has an authority to operate an SDN resource 200 included in the “first tenant”. Similarly, FIG. 3 illustrates that a “privileged APP” has an authority to operate SDN resources 200 included in the “first tenant” and a “second tenant”. Similarly, FIG. 3 illustrates that the “administrator” has an authority to operate resources included in the “second tenant”. Similarly, FIG. 3 illustrates that an “privileged administrator” has an authority to operate SDN resources 200 included in the “first tenant” and the “second tenant”.

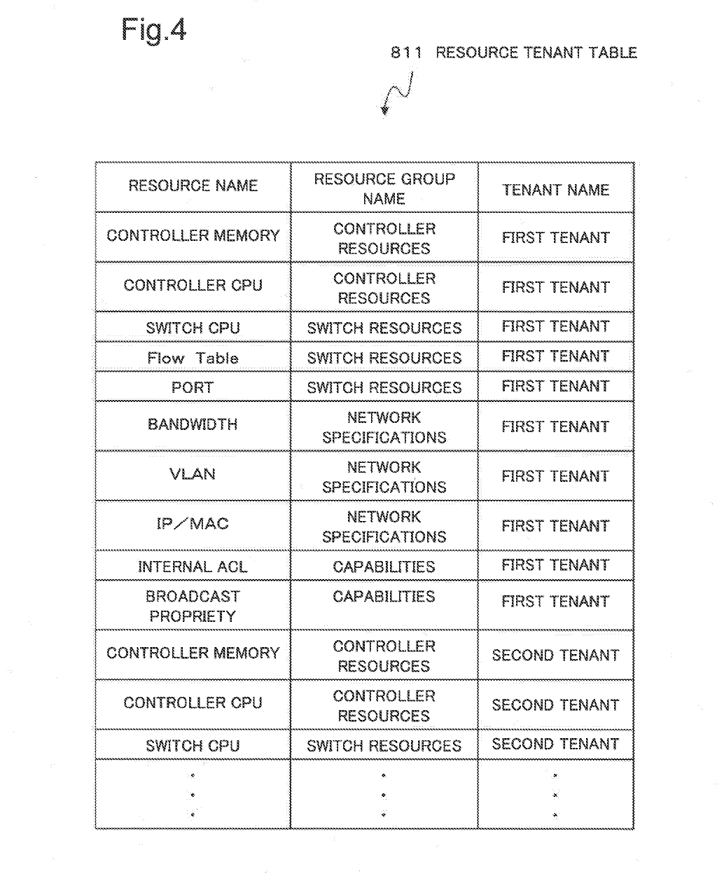

FIG. 4 is a diagram illustrating an example of a resource tenant table 811, which is a portion of the resource operation authority policies 810 in the present example embodiment. As illustrated in FIG. 4, the resource tenant table 811 contains records each of which includes a resource name identifying an SDN resource 200, a resource group name identifying a resource group, and a tenant name identifying a tenant. That is, the resource tenant table 811 indicates links among SDN resources 200, resource groups, and tenants.

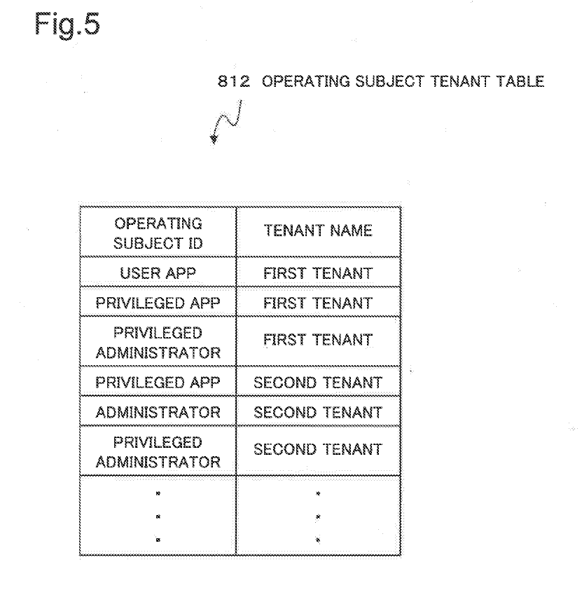

FIG. 5 is a diagram illustrating an example of an operating subject tenant table 812, which is a portion of the resource operation authority policies 810 in the present example embodiment. As illustrated in FIG. 5, the operating subject tenant table 812 contains records each of which includes an operating subject ID and a tenant name. The operating subject ID is an ID that uniquely identifies an operating subject. That is, the operating subject tenant table 812 indicates links between operating subjects and tenants.

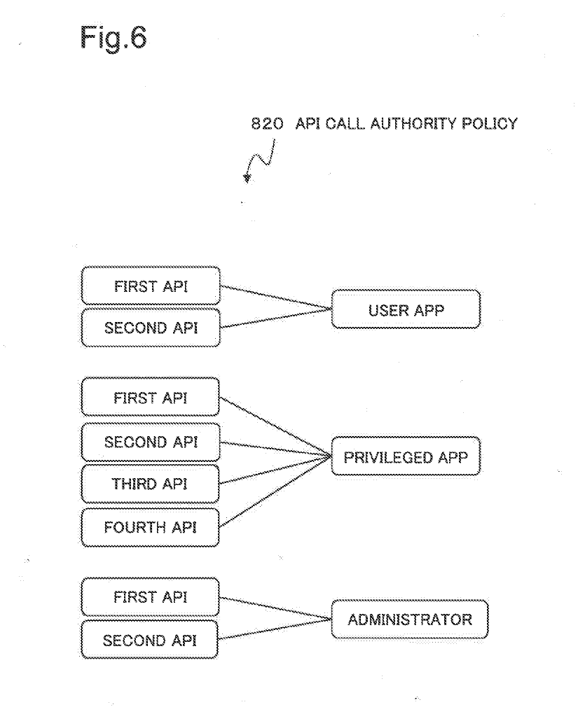

FIG. 6 is a diagram illustrating an example of a logical structure of the API call authority policies 820.

As illustrated in FIG. 6, the API call authority policies 820 indicate links between operating subjects and APIs. In other words, the API call authority policy 820 indicates which API(s) is an API(s) permitted to be executed by each operating subject.

The API call authority policies 820 also indicate links between operating subjects and APIs in an N:N (many-to-many) relationship. In other words, an operating subject may be linked with a plurality of APIs, and an API may be linked with a plurality of operating subjects.

For example, FIG. 6 illustrates that the “user APP” is able to call a first API and a second API. FIG. 6 also illustrates that the “privileged APP” is able to call the first API, the second API, a third API, and a fourth API. Furthermore, FIG. 6 illustrates that the “administrator” is able to call the first API and the second API.

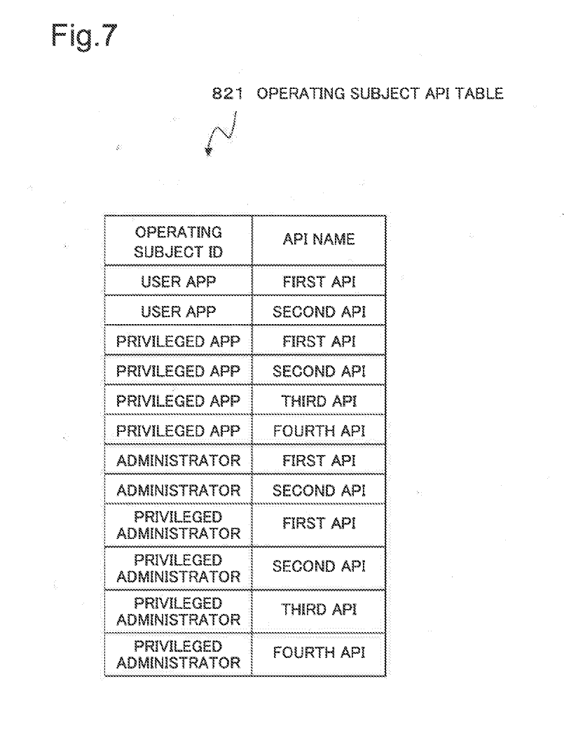

FIG. 7 is a diagram illustrating an example of an operating subject API table 821, which is a specific storage form of the API call authority policies 820 in the present example embodiment. As illustrated in FIG. 7, the operating subject API table 821 contains records each of which includes an operating subject ID and an API name identifying an API. That is, the operating subject API table 821 indicates links between operating subjects and APIs.

As described thus far, the resource control policies 800 of the present example embodiment associate sets (tenants) of network resources (for example, SDN resources 200), operations (APIs), and operating subjects with one another. In the present example embodiment, this configuration simplifies the description and maintenance of policies. Specifically, in a network environment, since a tenant is mainly defined on the basis of a service menu, the definition of a tenant rarely varies. Therefore, maintenance of the resource operation authority policies 810 seldom becomes necessary. The operations needed for a certain application are defined in advance and rarely change. Therefore, maintenance of the API call authority policies 820 seldom becomes necessary. Consequently, it is possible to reduce cost for the maintenance of the resource control policies 800.

When a function enhancement of the controller causes addition of a new operation or elimination and consolidation of types of operations, with the configuration of the resource control policies 800 of the present example embodiment, only the API call authority policies 820 illustrated in FIG. 6 may be updated. Therefore, it is possible to reduce cost for the update of policies against a system alteration.

In addition, the resource control policies 800 do not depend on the implementation form of an SDN controller. Thus, the resource control policies 800 have an advantage of, in an identical form, being able to cope with a plurality of controllers. Specifically, sets of resources, as described below, that are cut-out portions of a network are defined. The first set is a container in OpenDaylight (registered trademark). The second set is a tenant in Programmable Flow Controller. The third set is a slice in an application based on Trema, which is an open-source OpenFlow controller framework.

Since the resource control policies 800 associate such sets of resources with operating subjects (applications and administrators), the resource control policies 800 are applicable to any type of controller. At the time, tenants, containers and slices can be defined in a flexible manner using the resource operation authority policies 810 illustrated in FIG. 3.

===API Execution Propriety Determination Unit 110===

The API execution propriety determination unit 110 is the same as the API execution propriety determination unit 110 illustrated in FIG. 1.

That is, the API execution propriety determination unit 110 determines the propriety of execution of an API that has been called by the SDN application 201 and is used for operating the SDN resource 200 on the basis of the resource control policies 800 (the first policies and the second policies). Next, based on the determined propriety of the execution, the API execution propriety determination unit 110 calls the API provided by the API provision unit 104.

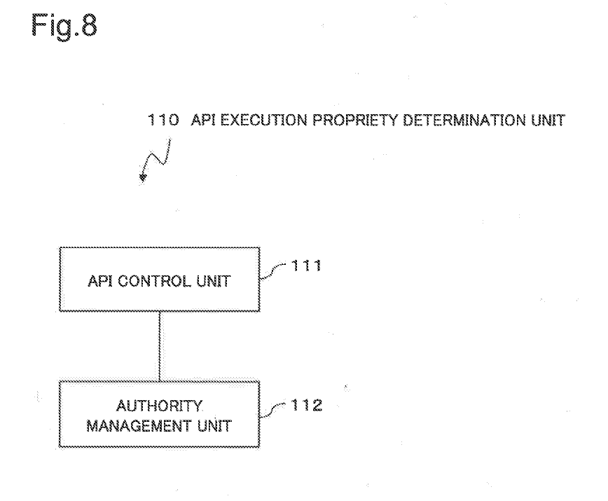

FIG. 8 is a diagram illustrating an example of an internal configuration of the API execution propriety determination unit 110. As illustrated in FIG. 8, the API execution propriety determination unit 110 includes, for example, an API control unit 111 and an authority management unit 112.

===API Control Unit 111===

The API control unit 111 monitors calling, by the SDN application 201, of an API, which is for operating the SDN resource 200 and is provided by the API provision unit 104, and inquires the authority management unit 112 of the propriety of execution of the API. Based on a result of the inquiry to the authority management unit 112 (propriety of execution determined by the authority management unit 112), the API control unit 111 calls the API.

Specifically, the API control unit 111 inquires the authority management unit 112 of the propriety of execution of the API as described below.

First, when an API is called by the SDN application 201, the API control unit 111 identifies the operating subject ID of the operating subject that has called the API. In this case, the operating subject ID is the application ID of the SDN application 201.

For example, the API control unit 111 identifies the application ID based on shared secret information (credential) provided in advance. The API control unit 111 may verify the electronic signature of the SDN application 201 to acquire the application ID.

Second, when the API is called, the API control unit 111 acquires an API name that is included in the API and identifies the called API.

Third, the API control unit 111 confirms an argument of the called API and identifies an SDN resource 200 that is operated by the API being executed.

In general, an API has a plurality of arguments. Therefore, the API control unit 111 may retain, on the inside thereof, a rule for determining which argument of each API specifies an SDN resource 200 that the API is to operate. When, for example, an API having a form of function 1 (argument 1, argument 2, argument 3) is defined, the API control unit 111 may store that the argument 3 is the argument specifying an SDN resource 200 that is an operation object. When the function 1 (API) is called, the API control unit 111 identifies an SDN resource 200 to be operated by the API based on the value of the argument 3.

Fourth, indicating the operating subject ID, the API name, and the resource name of the identified SDN resource 200, the API control unit 111 inquires the authority management unit 112 of the propriety of execution of the API.

===Authority Management Unit 112===

Receiving an inquiry from the API control unit 111, the authority management unit 112 determines the propriety of execution of the API on the basis of the resource control policies 800 (the first policies and the second policies) stored in the resource control policy DB 103.

Specifically, first, the authority management unit 112 receives an operating subject ID, an API name, and a resource name from the API control unit 111.

Second, the authority management unit 112 compares a pair of the operating subject ID and the API name with the contents of the API call authority policies 820 illustrated in FIG. 6. On the basis of a result of the comparison, the authority management unit 112 confirms whether an operating subject identified by the operating subject ID is permitted to execute an API identified by the API name.

Specifically, if the operating subject and the API are linked with each other in an API call authority policy 820, the authority management unit 112 determines that the operating subject is permitted to execute the API.

Third, the authority management unit 112 compares the operating subject ID and the resource name with the resource operation authority policies 810 illustrated in FIG. 3. On the basis of a result of the comparison, the authority management unit 112 confirms whether an operating subject identified by the operating subject ID is permitted to operate an SDN resource 200 identified by the resource name.

Specifically, if the operating subject and the SDN resource 200 are linked with each other in a resource operation authority policy 810, the authority management unit 112 determines that the operating subject is permitted to operate the SDN resource 200.

Fourth, if the execution of the API and the operation of the SDN resource 200 are permitted, the authority management unit 112 notifies the API control unit 111 that the API is executable. If at least either one of the execution of the API and the operation of the SDN resource 200 is not permitted, the authority management unit 112 notifies the API control unit 111 that the API is un-executable.

===API Provision Unit 104===

The API provision unit 104 provides the SDN application 201 with an API(s) for operating the SDN resource 200. In other words, the API provision unit 104 executes a called API(s) to operate the SDN resource 200.

The above is a description of the respective components of the functional units of the network resource management system 400 and the network resource management system 401.

Next, components of hardware units of the network resource management system 400 and the network resource management system 401 will be described.

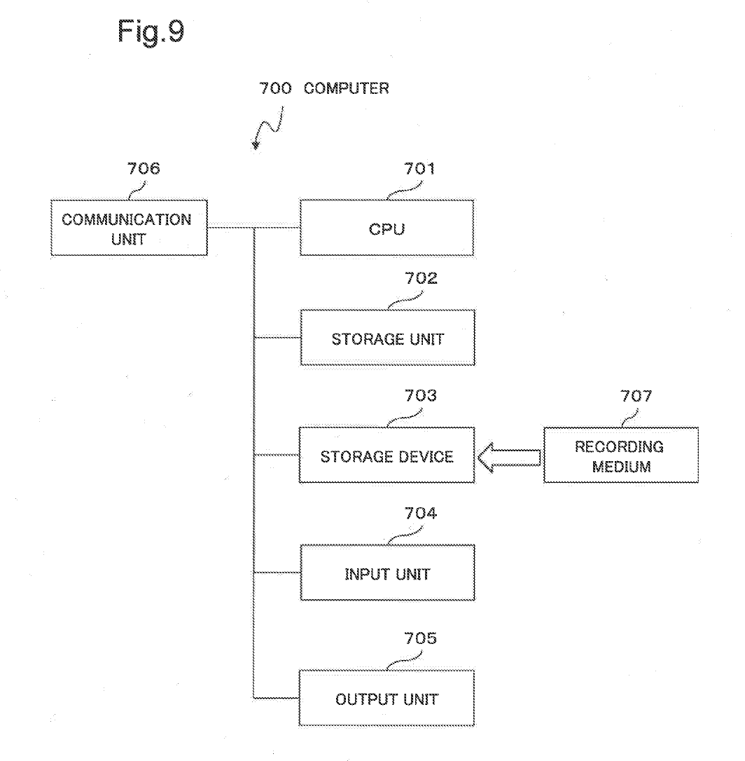

FIG. 9 is a diagram illustrating a hardware configuration of a computer 700 that achieves the network resource management system 400 and the network resource management system 401 in the present example embodiment.

As illustrated in FIG. 9, the computer 700 includes a CPU 701, a storage unit 702, a storage device 703, an input unit 704, an output unit 705, and a communication unit 706. In addition, the computer 700 includes a recording medium (or storage medium) 707, which is provided from the outside. For example, the recording medium 707 is a nonvolatile recording medium (non-transitory recording medium), which stores information non-temporarily. The recording medium 707 may also be a transitory recording medium, which retains information as a signal.

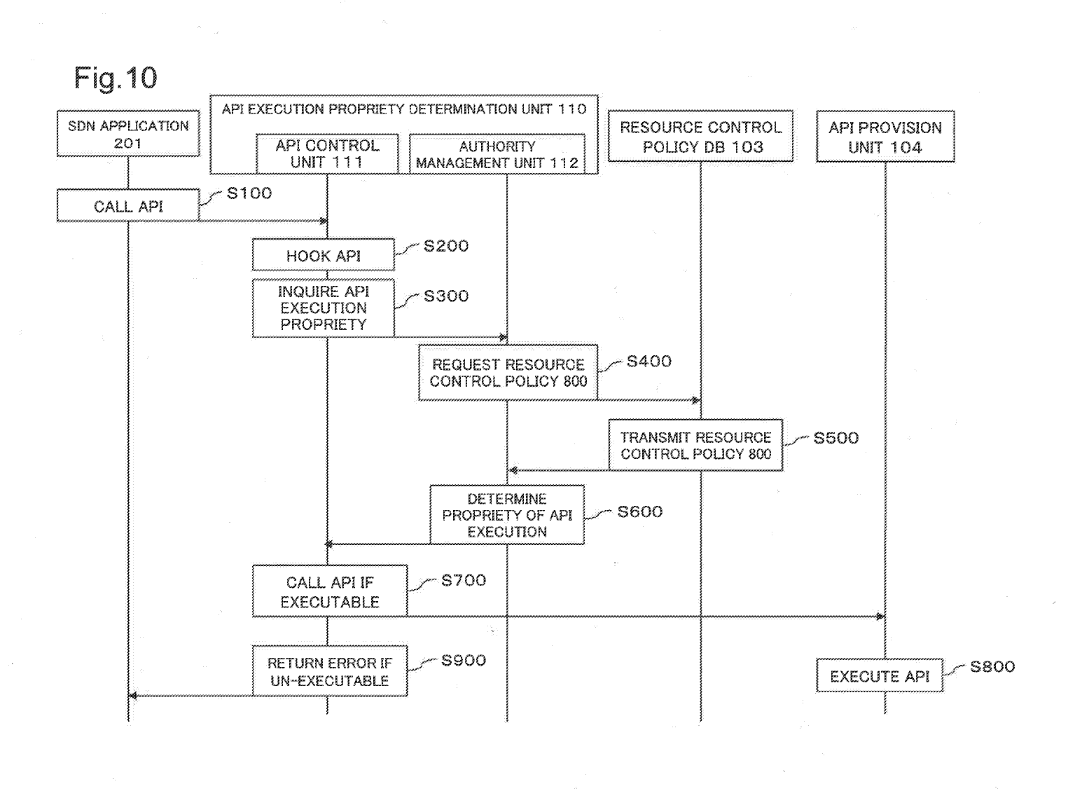

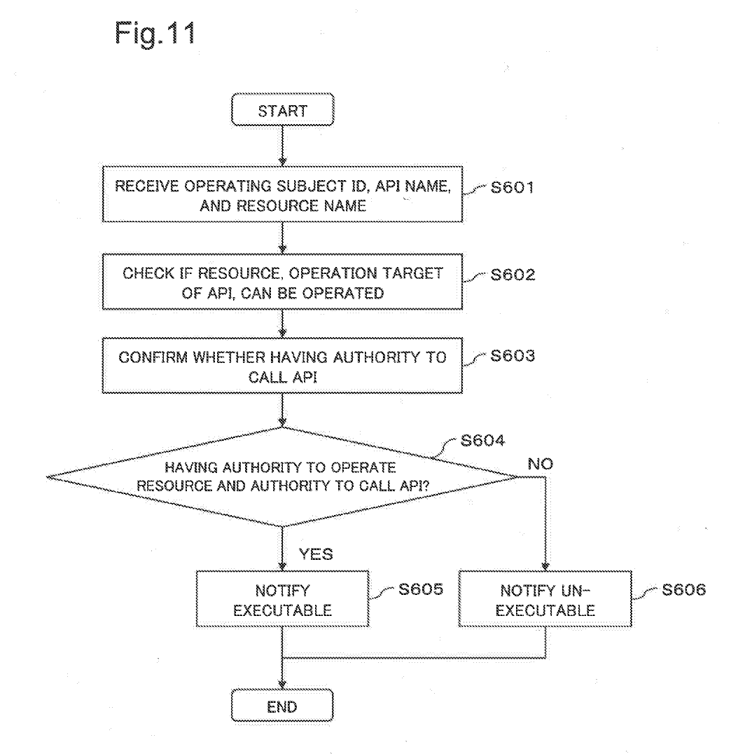

The CPU 701 makes an operating system (not illustrated) operate to control the entire operation of the computer 700. For example, the CPU 701 reads programs and data from the recording medium 707 mounted on the storage device 703 and writes the read programs and data into the storage unit 702. The above programs are, for example, programs for making the computer 700 execute an operation illustrated in a sequence diagram in FIG. 10 and a flowchart in FIG. 11, which will be described later.

The CPU 701 executes various processing as the API execution propriety determination unit 110 illustrated in FIGS. 1 and 2 in accordance with the read programs and based on the read data.

The CPU 701 may download the programs and data from an external computer (not illustrated) connected to a communication network (not illustrated) into the storage unit 702.

The storage unit 702 stores the programs and data. The storage unit 702 may store the resource control policies 800. The storage unit 702 may be included in the API execution propriety determination unit 110 and resource control policy DB 103 as a portion thereof.

The storage device 703 is, for example, an optical disk, a flexible disk, a magneto optical disk, an external hard disk, a semiconductor memory or the like, and includes the recording medium 707. The storage device 703 (the recording medium 707) stores the programs in a computer-readable manner. The storage device 703 may store the data (for example, the resource control policies 800). The storage device 703 may be included in the API execution propriety determination unit 110 and resource control policy DB 103 as a portion thereof.

The input unit 704 receives input of an operation from an operator and input of information from the outside. Devices used in the input operation include, for example, a mouse, a keyboard, a built-in key button, and a touch panel. The input unit 704 may be included in the API execution propriety determination unit 110 as a portion thereof.

The API execution propriety determination unit 110 may receive input of the resource operation authority policies 810 through the input unit 704 and record the resource operation authority policies 810 in the storage unit 702 and storage device 703. The API execution propriety determination unit 110 may also receive input of the API call authority policies 820 through the input unit 704 and record the input in the storage unit 702 and storage device 703.

The output unit 705 is achieved by, for example, a display. The output unit 705 is used for, for example, requesting input from an operator and presenting output to the operator by use of GUIs (GRAPHICAL User Interface). The output unit 705 may be included in the API execution propriety determination unit 110 as a portion thereof.

When determining that the afore-described API is un-executable, the API execution propriety determination unit 110 may output, by way of the output unit 705, information that relates to the determination result and is included in the resource operation authority policies 810 and API call authority policies 820.

The communication unit 706 achieves an interface with external systems. The communication unit 706 may be included in the API execution propriety determination unit 110 as a portion thereof. In the case of FIG. 1, the external systems may include, for example, external storage means for storing the resource operation authority policies 810 and the API call authority policies 820, a computer in which an operating subject operates, network resources, and a computer that executes APIs. In the case of FIG. 2, the external systems include, for example, an SDN resource 200. In this case, the SDN application 201 and the API provision unit 104 may operate in the computer 700 the same as the network resource management system 401.

As described thus far, the blocks of the functional units of the network resource management system 400 and the network resource management system 401 illustrated in FIG. 1 are achieved by the computer 700 having a hardware configuration illustrated in FIG. 9. However, means for achieving the respective units included in the computer 700 is not limited to the above-described means. That is, the computer 700 may be achieved by a physically-coupled single device or may be achieved by a plurality of devices that are two or more physically-separated devices interconnected in a wired or wireless manner.

When a recording medium 707 recording the codes of the above-described programs is provided to the computer 700, the CPU 701 may read and execute the codes of the programs contained in the recording medium 707. Alternatively, the CPU 701 may store the codes of the programs contained in the recording medium 707 into the storage unit 702 or the storage device 703 or both thereof. That is, the present example embodiment includes an example embodiment of a recording medium 707 storing, in a transitory or non-transitory manner, the programs (software) executed by the computer 700 (the CPU 701). Storage media storing information in a non-transitory manner are also referred to as nonvolatile storage media.

The above is a description of the respective components of hardware units of the computer 700 that achieves the network resource management system 400 and the network resource management system 401 in the present example embodiment.

Next, an operation of the present example embodiment will be described in detail with reference to the accompanying drawings.

FIG. 10 is a sequence diagram illustrating an operation of the information processing system 10 illustrated in FIG. 2. FIG. 10 includes operations of the network resource management system 400 illustrated in FIG. 1 and the network resource management system 401 illustrated in FIG. 2. The processing illustrated in the sequence diagram may be executed based on the afore-described program control performed by the CPU 701. The names of processing steps are indicated by symbols, as in S100.

The SDN application 201 calls an API provided by the API provision unit 104 (step S100). For example, the calling of an API may be performed locally in the SDN controller 100. APIs may also be called remotely by way of a network, using REST (Representational State Transfer).

Next, the API control unit 111 of the API execution propriety determination unit 110 hooks the calling of an API in step S100 (step S200).

Methods for hooking include a method of watching communication between the SDN application 201 and the API provision unit 104 and a method of watching an API executed by the API provision unit 104, and are not limited to a specific method.

Next, based on the hooked API, the API control unit 111 acquires the operating subject ID of the operating subject that has called the API, the API name, and the resource name of the SDN resource 200 that is an operation object. Subsequently, indicating the operating subject ID, the API name, and the resource name, the API control unit 111 inquires the authority management unit 112 of the propriety of execution of the API (step S300).

For example, there is a case in which an application A calls “show_stat(object switch)”, which is a function for displaying statistical information, to acquire information on a switch S. In this case, the ID of the application, the API name, and the resource name are “application A”, “show_stat”, and “switch S”, respectively.

Next, the authority management unit 112 requests, to the resource control policy DB 103, resource control policies 800 (a resource operation authority policy(ies) 810 and an API call authority policy(ies) 820) (step S400).

Next, the resource control policy DB 103 transmits the resource control policies 800 (the resource operation authority policy(ies) 810 and API call authority policy(ies) 820) (step S500).

Next, on the basis of the resource control policies 800 and the information received from the API control unit 111, the authority management unit 112 determines whether the API is executable or un-executable, and notifies the API control unit 111 of a result of the determination (step S600). The details of step S600 will be described later.

Next, if a result notified from the authority management unit 112 is “executable”, the API control unit 111 calls the API provision unit 104 (step S700).

Next, the API provision unit 104 executes the API to operate the SDN resource 200 (step S800).

If the result is “un-executable”, the API control unit 111 notifies the SDN application 201 of an error (step S900).

Through the operations described thus far, the SDN controller 100 controls the propriety of execution of the API called by the SDN application 201. Although, in the above description, an operation in which an SDN application 201 calls an API was described, the SDN controller 100 is also capable of controlling the propriety of calling of an API through the same operation even when an administrator calls the API.

Next, step S600 will be described in detail using FIG. 11. FIG. 11 is a flowchart illustrating an operation of the authority management unit 112 of the API execution propriety determination unit 110 in the present example embodiment.

The authority management unit 112 of the API execution propriety determination unit 110 receives the operating subject ID, the API name, and the resource name from the API control unit 111 (step S601).

Next, the authority management unit 112 determines whether the SDN application 201 is capable of operating the SDN resource 200 that is a target of the operation by the API (step S602).

Specifically, based on the operating subject ID, the authority management unit 112 searches the operating subject tenant table 812, illustrated in FIG. 5, of the resource operation authority policies 810 for the SDN application 201. The authority management unit 112 identifies a tenant(s) linked with the SDN application 201. The number of the tenants is one or plural. Next, based on the resource name, the authority management unit 112 searches the resource tenant table 811, illustrated in FIG. 4, of the resource operation authority policies 810. The authority management unit 112 confirms whether the SDN resource 200, which is a target of the operation by the API, is associated with the tenant(s) with which the SDN application 201 is linked. If the SDN resource 200 is associated with the tenant(s), the authority management unit 112 determines that the SDN resource 200 can be operated, and, if the SDN resource 200 is not associated with the tenant(s), the authority management unit 112 determines that the SDN resource 200 may not be operated.

Next, the authority management unit 112 determines whether the operating subject, which is identified by the operating subject ID, has an authority to call the API (step S603).

Specifically, based on the operating subject ID and the API name, the authority management unit 112 checks the API call authority policies 820 illustrated in FIG. 6 to confirm whether the operating subject ID is associated with the API name. That is, the authority management unit 112 confirms whether the operating subject has an authority to execute the API.

Next, the authority management unit 112 confirms whether it has been confirmed, in step S602, that the SDN resource 200 can be operated and, in step S603, that the operating subject has an authority to call the API (step S604).

If the condition in step S604 is satisfied (YES in step S604), the authority management unit 112 determines that it is permissible to execute the API and notifies the API control unit 111 that the API is “executable” (step S605).

If the condition in step S604 is not satisfied (NO in step S604), the authority management unit 112 notifies the API control unit 111 that the API is “un-executable” (step S606).

A first advantageous effect of the above-described present example embodiment is that it becomes possible to achieve execution propriety control of APIs that provide control functions of network resources for each combination of an operating subject, a network resource, and an operation at a lower cost.

That is because the API execution propriety determination unit 110 determines the propriety of execution of an API called by an operating subject on the basis of the resource control policies 800, and, based on a result of the determination, instructs, to means for executing the API, the execution of the API.

A second advantageous effect of the above-described present example embodiment is that it becomes possible to control controls of various network resources, such as an IP address and a MAC address, the bandwidth of a network, and a FlowTable of an OpenFlow switch, in an integrated manner.

That is because sets of various types of network resources are defined in the resource operation authority policies 810 in a flexible manner, and such sets of resources, operating subjects, and operations are associated with one another using the resource control policies 800.

A third advantageous effect of the above-described present example embodiment is that it becomes possible to achieve, with a desired accuracy and at a lower cost, execution propriety control of APIs that provide control functions of network resources in SDNs implemented in various ways.

That is because sets of resources in SDNs implemented in various ways are defined in the resource operation authority policies 810 in a flexible manner, and such sets of resources, operating subjects, and operations are associated with one another using the resource control policies 800.

<<<Variation of First Example Embodiment>>>

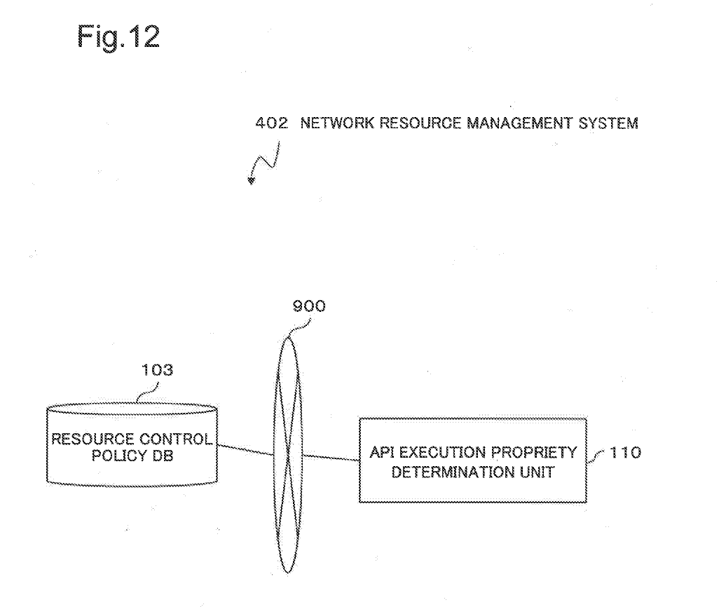

FIG. 12 is a diagram illustrating a network resource management system 402, which is a variation of the first example embodiment. As illustrated in FIG. 12, the network resource management system 402 includes an API execution propriety determination unit 110 illustrated in FIGS. 1 and 2 and a resource control policy DB 103 illustrated in FIG. 2. The API execution propriety determination unit 110 and the resource control policy DB 103 are interconnected by way of a network 900. The API execution propriety determination unit 110 and the resource control policy DB 103 may be configured as a single computer 700 as illustrated in FIG. 9 and may also be connected to each other directly without interposing a network therebetween.

===Resource Control Policy DB 103===

The resource control policy DB 103 is equivalent to the resource control policy DB 103 illustrated in FIG. 2.

In the present variation, the API execution propriety determination unit 110 acquires resource control policies 800 from the resource control policy DB 103 by way of the network 900.

An advantageous effect of the above-described variation of the present example embodiment is that it becomes possible to achieve, in a flexible manner, construction of the network resource management system 402 that controls the propriety of operation of network resources.

That is because, the API execution propriety determination unit 110 and the resource control policy DB 103 are interconnected by way of the network 900.

### Second Example Embodiment

Next, a second example embodiment of the present invention will be described in detail with reference to the accompanying drawings. Hereinafter, within a range not to obscure the description of the present example embodiment, descriptions of portions overlapping the earlier description will be omitted.

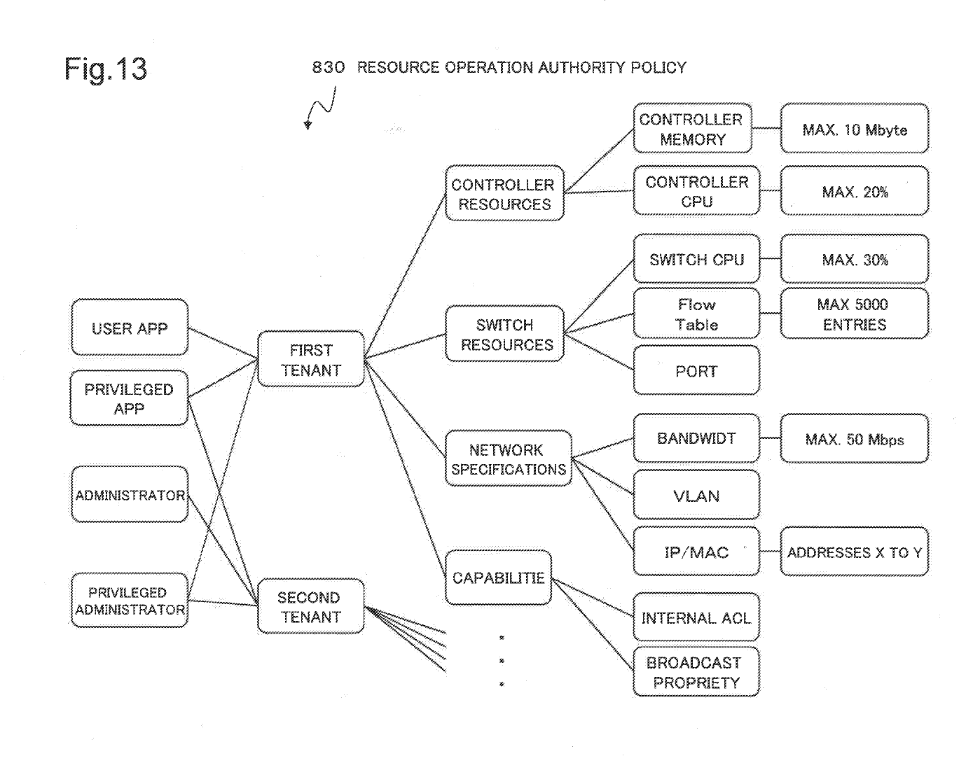

The second example embodiment differs from the first example embodiment in that resource control policies 800 include resource operation authority policies 830 as illustrated in FIG. 13 in place of the resource operation authority policies 810. The second example embodiment further differs from the first example embodiment in that an API execution propriety determination unit 110 determines the propriety of execution of APIs on the basis of information (hereinafter, referred to as limiting values) specifying ranges within which network resources are permitted to be used.

FIG. 13 is a diagram illustrating a structure of the resource operation authority policies 830 in the present example embodiment. The resource operation authority policies 810 illustrated in FIG. 3 indicate network resources that operating subjects are permitted to operate. On the other hand, as illustrated in FIG. 13, the resource operation authority policies 830 further specify limiting values for respective network resources that operating subjects are permitted to operate.

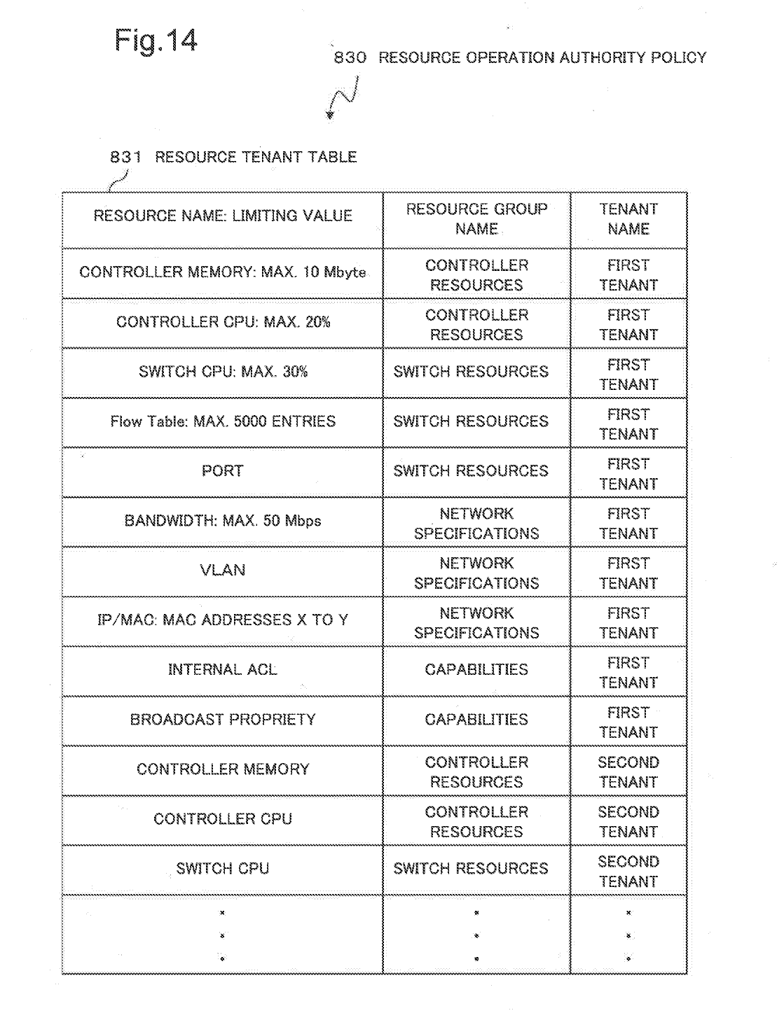

FIG. 14 is a diagram illustrating an example of a resource tenant table 831, which is a specific storage form, of the resource operation authority policies 830 in the present example embodiment. As illustrated in FIG. 14, the resource tenant table 831 contains records each of which includes a resource name identifying an SDN resource 200 and a limiting value, a resource group name identifying a resource group, and a tenant name identifying a tenant. That is, the resource tenant table 831 indicates links among SDN resources 200 and limiting values thereof, resource groups, and tenants.

When, in the case of executing an API, the amount of usage of a network resource linked with a certain tenant exceeds a limiting value specified in a resource operation authority policy 830, the API execution propriety determination unit 110 of the present example embodiment determines that the API is un-executable.

Specifically, first, the API execution propriety determination unit 110 retains a current amount of usage of each of the SDN resources 200 linked with a tenant in, for example, a storage unit 702 illustrated in FIG. 9.

Second, in determining the propriety of execution of an API, the API execution propriety determination unit 110 calculates a prediction value for the amount of usage of each SDN resource 200 in the case of the API being executed.

Third, the API execution propriety determination unit 110 determines that the API is executable when the prediction value is not greater than the limiting value, and determines that the API is un-executable when the prediction value exceeds the limiting value.

For example, it is assumed that, when the maximum amount of Flow entry usage of a switch resource is 5000 entries, an operating subject calls an API for adding a Flow entry. In this case, the API execution propriety determination unit 110 determines whether execution of the API causes the number of Flow entries that are used by a tenant to which the operating subject belongs to exceed 5000 entries and, if exceeding 5000 entries, determines that the API is un-executable.

Similarly, the API execution propriety determination unit 110 may also determine the propriety of execution of an API on the basis of an amount of usage of any network resource with a limiting value specified, such as an amount of usage of the CPU or memory of the controller resources and a bandwidth of the network.

Having the configuration described thus far enables influence on the performance of another tenant to be reduced even when a certain tenant has a high load because maximum amounts of network resources available for the tenant are predetermined.

When certain operating subjects, for example, belong to a plurality of tenants, a privileged APP illustrated in FIG. 13 may not identify a tenant uniquely from the operating subjects. In this case, an SDN application 201 may, in calling an API, transmit information for identifying a tenant to the API execution propriety determination unit 110. The API execution propriety determination unit 110 may determine the propriety of execution of the API further on the basis of the information for identifying the tenant.

The resource operation authority policy 830 may include a limiting value that is set for each operating subject. For example, limiting values for a privileged APP and a privileged administrator may specify a range wider than that specified by limiting values for a user APP and an administrator.

A first advantageous effect of the above-described present example embodiment is that it becomes possible to prevent a load state of a specific tenant from influencing the performance of another tenant, in addition to the advantageous effects of the first example embodiment.

That is because the resource operation authority policies 830 include limiting values and the API execution propriety determination unit 110 determines the propriety of execution of an API further on the basis of the limiting values.

A second advantageous effect of the above-described present example embodiment is that it becomes possible to assign a degree of priority for each tenant in determining the propriety of execution of an API.

That is because the resource operation authority policies 830 include a limiting value for each tenant, and the API execution propriety determination unit 110 determines the propriety of execution of an API on the basis of the limiting value for each tenant.

### Third Example Embodiment

Next, a third example embodiment of the present invention will be described in detail with reference to the accompanying drawings. Hereinafter, within a range not to obscure the description of the present example embodiment, descriptions of portions overlapping the earlier description will be omitted.

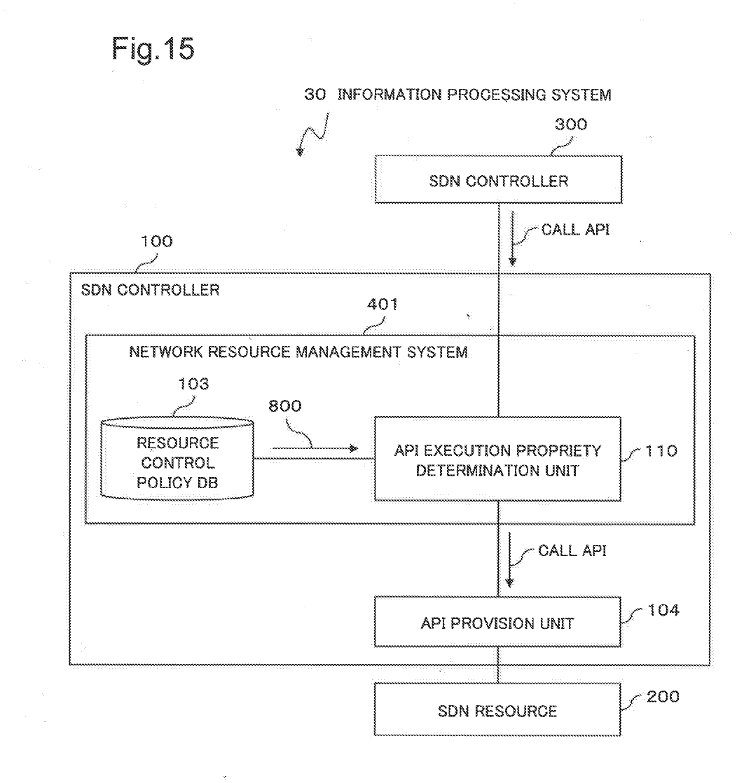

FIG. 15 is a block diagram illustrating a configuration of an information processing system 30 in the third example embodiment of the present invention.

As illustrated in FIG. 15, the information processing system 30 in the present example embodiment differs from the information processing system 10 of the first example embodiment in that an SDN controller 300, in place of the SDN application 201, is connected.

The SDN controller 300, for example, has functions equivalent to those of an SDN controller 100.

In the description of the information processing system 10 of the first example embodiment illustrated in FIG. 2, an API execution propriety determination unit 110 monitors an API call from an SDN application 201 and controls the propriety of execution of the API. Furthermore, as illustrated in FIG. 15, the API execution propriety determination unit 110 may monitor an API call from another SDN controller 300.

The SDN controller 100 may monitor API calls from an arbitrary number of SDN applications 201 and SDN controllers 300.

In this case, resource control policies 800 include a policy(ies) that the SDN controller 300 is regarded as an operating subject.

A first advantageous effect of the above-described present example embodiment is that it becomes possible to control the propriety of execution of an API in operating SDN controllers in a coordinated manner, in addition to the advantageous effects of the first example embodiment. Specifically, even when another coordinated SDN controller 300 has a bug or is taken over, it is possible to prevent influence of the abnormality at the SDN controller 300 from proliferating to an SDN resource 200 that is controlled by the SDN controller 100.

That is because the API execution propriety determination unit 110 controls the propriety of execution of an API on the basis of the resource control policies 800 that include the SDN controller 300 as an operating subject.

Each of components in the respective example embodiments described thus far does not always need to be components that are individually independent. For example, a plurality of arbitrary components may be achieved as a single module. Any one component out of the components may be achieved by a plurality of modules. Any one component out of the components may be arbitrary another component out of the components. Further, a portion of any one component out of the components may overlap a portion of arbitrary another component out of the components.

The respective components and the modules achieving the respective components in the respective example embodiments described thus far may, if possible, be achieved in hardware as needed basis. The respective components and the modules achieving the respective components may also be achieved by a computer and programs. The respective components and the modules achieving the respective components may also be achieved by a mixture of modules configured in hardware, and a computer and programs.

The programs are recorded in a computer-readable non-transitory recording medium, such as a magnetic disk and a semiconductor memory, and are provided to the computer. The programs are read from the non-transitory recording medium into the computer at the start-up or the like of the computer. The read programs control the operation of the computer to make the computer function as the components in the respective example embodiments described afore.

Although, in the respective example embodiments described thus far, a plurality of operations are described in order in flowchart forms, the description sequence does not restrict the execution sequence of the plurality of operations. Therefore, when the respective example embodiments are embodied, the sequence of the plurality of operations may be changed within a range of not adversely affecting the results of the operations.

In addition, in the respective example embodiments described thus far, the plurality of operations are not limited to be executed at timings differing from one another. For example, during execution of an operation, another operation may be executed. The execution timings of an operation and another operation may overlap each other partially or completely.

Furthermore, although, in the respective example embodiments described thus far, it is described that an operation becomes a triggering event for another operation, the description does not restrict the relation between an operation and another operation. Thus, when the respective example embodiments are embodied, the relations among the plurality of operations may be changed within a range of not adversely affecting the results of the operations. The specific descriptions of the respective operations of the respective components do not restrict the respective operations of the respective components. Thus, the specific respective operations of the respective components may be changed within a range of not adversely affecting functional, performance-related, and other characteristics in embodying the respective example embodiments.

The present invention is described above with reference to the respective example embodiments, but the present invention is not limited to the example embodiments described above. Various modifications that could be understood by a person skilled in the art may be applied to the configurations and details of the present invention within the scope of the present invention.

This application claims priority based on Japanese Patent Application No. 2014-148667, filed on Jul. 22, 2014, the entire disclosure of which is incorporated herein by reference.

### REFERENCE SIGNS LIST

10 Information processing system
30 Information processing system
100 SDN controller
103 Resource control policy DB
104 API provision unit
110 API execution propriety determination unit
111 API control unit
112 Authority management unit
200 SDN resource
201 SDN application
300 SDN controller
400 Network resource management system
401 Network resource management system
402 Network resource management system
700 Computer
701 CPU
702 Storage unit
703 Storage device
704 Input unit
705 Output unit
706 Communication unit
707 Recording medium
800 Resource control policy
810 Resource operation authority policy
811 Resource tenant table
812 Operating subject tenant table
820 API call authority policy
821 Operating subject API table
830 Resource operation authority policy
831 Resource tenant table
900 Network

1. An information processing system, comprising:
one or more processors acting as a execution propriety determination unit configured to based on a first policy and a second policy, determine propriety of execution of an application programming interface that is called by an operating subject and is used for controlling a network resource, and, based on the determined propriety of the execution, instructing, to a unit configured to execute the application programming interface, execution of the application programming interface,
the first policy indicating a correspondence between the operating subject and a tenant that is a set of the network resources that the operating subject is permitted to operate, and the second policy indicating a correspondence between the operating subject and an application programming interface the execution of which by the operating subject is permitted.

2. The information processing system according to claim 1, wherein
the first policy further includes a limiting value for an amount of usage of each of the network resources that belong to the tenant, and
when a prediction value of an amount of usage of the network resource linked with the tenant exceeds the limiting value, the execution propriety determination unit determines that the application programming interface is un-executable.

3. The information processing system according to claim 2, wherein
the limiting value is set for each operating subject.

4. The information processing system according to claim 1, further comprising:
a policy storage unit configured to store at least either one of the first policy and the second policy; and
the one or more processors acting as a unit configured to input the first policy and the second policy that are stored in the policy storage unit.

5. The information processing system according to claim 1, further comprising
the one or more processors acting as a unit configured to, when the execution propriety determination means determines propriety of execution of the application programming interface that is called by the operating subject and is for controlling the network resource in the network to be un-executable, output information that relates to the determined result and is included in the first policy and the second policy.

6. The information processing system according to claim 1, wherein
the first policy includes information in which a network control device that is a unit configured to execute the application programming interface is defined as the operating subject, and
the execution propriety determination unit further determines propriety of execution of the application programming interface by the network control device.

7. (canceled)

8. A network resource management method, the method comprising:
determining propriety of execution of an application programming interface that is called by an operating subject and used for controlling a network resource, based on a first policy that indicates a correspondence between the operating subject and a tenant that is a set of the network resources that the operating subject is permitted to operate and a second policy that indicates a correspondence between the operating subject and an application programming interface the execution of which by the operating subject is permitted; and
based on the determined propriety of the execution, instructing, to a unit configured to execute the application programming interface, execution of the application programming interface.

9. A computer-readable non-transitory recording medium recording a program, the program making a computer execute processes of:
determining propriety of execution of an application programming interface that is called by an operating subject and used for controlling a network resource, based on a first policy that indicates a correspondence between the operating subject and a tenant that is a set of the network resources that the operating subject is permitted to operate and a second policy that indicates a correspondence between the operating subject and an application programming interface the execution of which by the operating subject is permitted; and
based on the determined propriety of the execution, instructing, to a unit configured to, execute the application programming interface, execution of the application programming interface.

10. The information processing system according to claim 2, further comprising:
a policy storage unit configured to store at least either one of the first policy and the second policy; and
the one or more processors acting as a unit configured to input the first policy and the second policy that are stored in the policy storage unit.

11. The information processing system according to claim 3, further comprising:
a policy storage unit configured to store at least either one of the first policy and the second policy; and
the one or more processors acting as a unit configured to input the first policy and the second policy that are stored in the policy storage unit.

12. The information processing system according to claim 2, further comprising
the one or more processors acting as a unit configured to, when the execution propriety determination means determines propriety of execution of the application programming interface that is called by the operating subject and is for controlling the network resource in the network to be un-executable, output information that relates to the determined result and is included in the first policy and the second policy.

13. The information processing system according to claim 3, further comprising
the one or more processors acting as a unit configured to, when the execution propriety determination means determines propriety of execution of the application programming interface that is called by the operating subject and is for controlling the network resource in the network to be un-executable, output information that relates to the determined result and is included in the first policy and the second policy.

14. The information processing system according to claim 4, further comprising
the one or more processors acting as a unit configured to, when the execution propriety determination means determines propriety of execution of the application programming interface that is called by the operating subject and is for controlling the network resource in the network to be un-executable, output information that relates to the determined result and is included in the first policy and the second policy.

15. The information processing system according to claim 2, wherein
the first policy includes information in which a network control device that is a unit configured to execute the application programming interface is defined as the operating subject, and
the execution propriety determination unit further determines propriety of execution of the application programming interface by the network control device.

16. The information processing system according to claim 3, wherein
the first policy includes information in which a network control device that is a unit configured to execute the application programming interface is defined as the operating subject, and
the execution propriety determination unit further determines propriety of execution of the application programming interface by the network control device.

17. The information processing system according to claim 4, wherein
the first policy includes information in which a network control device that is a unit configured to execute the application programming interface is defined as the operating subject, and
the execution propriety determination unit further determines propriety of execution of the application programming interface by the network control device.
